(19) United States
(12) Patent Application Publication
(10) Pub. No.: US 2024/0119722 A1
(43) Pub. Date: Apr. 11, 2024

(54) REDUCING IDENTIFICATION LIMITATIONS

(71) Applicant: AUTOBRAINS TECHNOLOGIES LTD, Tel Aviv-Yafo (IL)

(72) Inventor: Shir Tibor, Tel Aviv-Yafo (IL)

(73) Assignee: AUTOBRAINS TECHNOLOGIES LTD, Tel Aviv-Yafo (IL)

(21) Appl. No.: 18/482,005

(22) Filed: Oct. 5, 2023

Related U.S. Application Data
(60) Provisional application No. 63/378,504, filed on Oct. 5, 2022.

(51) Int. Cl. G06V 10/82; B60W 30/00

(52) U.S. Cl. CPC G06V 10/82; B60W 30/00; B60W 2420/42

(57) ABSTRACT

A method for overcoming a detection limitation of a neural network, the method includes obtaining a sensed information unit that captures an object; obtaining an indication for a detection limitation of the neural network with respect to the object, wherein the detection limitation of the neural network prevents the neural network from generating a neural network output that is indicative of the object with at least a desirable certainty; feeding the sensed information unit to the neural network to provide a neural network output; and controlling a detection of the object by the neural network based on an indication that the object is captured in the sensed information unit.

### BACKGROUND

In order to reduce the size and/or complexity of an object detection neural network, the object detection neural network is trained to detect objects of a certain size range. Accordingly—objects that are outside the certain size range—for example—a object of a size that is smaller than the smallest size of the certain size range—is ignored of.

There is a growing need to allow to detect objects outside the certain size range without dramatically increasing the complexity of the object detection neural network.

### SUMMARY

There may be provided systems, method and non-transitory computer readable medium for reducing identification limitations by using prior knowledge.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a vehicle;

FIG. 3 illustrates an example of an implementation of the method; and

FIG. 4 illustrates an example of an implementation of the method.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

The specification and/or drawings may refer to an information unit. The information unit may be a sensed information unit. The sensed information unit may capture or may be indicative of a natural signal such as but not limited to signal generated by nature, signal representing human behavior, signal representing operations related to the stock market, a medical signal, audio signal, visual information signal, and the like. Sensed information may be sensed by any type of sensors—such as a visual light camera, or a sensor that may sense infrared, radar imagery, ultrasound, electro-optics, radiography, LIDAR (light detection and ranging), etc.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

There may be provide a system, a method, and a non-transitory computer readable medium for overcoming a detection limitation of a neural network.

This provides a technical solution that overcomes the limitation of a neural network. This solution saves computational and/or storage resources as there is no need to invest in a more resource consuming neural network capable of overcoming this limitation. The resource reduction is especially true when the information used to overcome the detection limitation is one or more features (or any other information) generated by the neural network during a previous point in time.

The usage of the term “may be A” indicates that according to an embodiment A is provided or presented or exists.

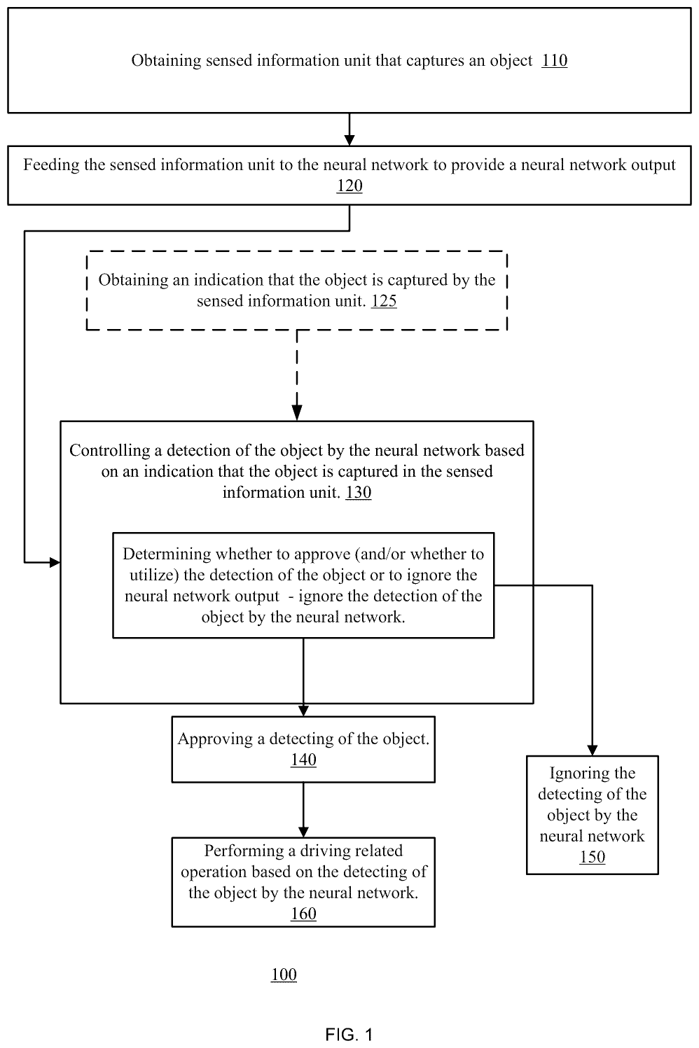

FIG. 1 illustrates method 100 for overcoming a detection limitation of a neural network using additional knowledge.

Method 100 may start by step 110 of obtaining sensed information unit that captures an object. The obtaining may include sensing the sensed information by one or more sensing unit or receiving the sensed information from the one or more sensing unit and/or from a memory unit or other unit.

The detection limitation of the neural network prevents the neural network from generating a neural network output that is indicative of the object with at least a desirable certainty.

What amounts to a desirable certainty may be defined by a vehicle manufacturer, my a technician, by a user. The desirable certainty may depend on the training process of the neural network.

Step 110 may be followed by step 120 of feeding the sensed information unit to the neural network to provide a neural network output.

Step 120 may be followed by step 130 of controlling a detection of the object by the neural network based on an indication that the object is captured in the sensed information unit. According to an embodiment, step 130 includes determining whether to (a) approve (and/or whether to utilize) the detection of the object or (b) to ignore the neural network output—ignore the detection of the object by the neural network.

Step 130 may be followed by step 140 of approving a detecting of the object by the neural network when obtaining (step 125) an indication that the object is captured by the sensed information unit. Step 125 is represented by dashed step 125—as such an indication may not be received during an iteration of method 100.

Step 130 may be followed by step 150 of ignoring the detecting of the object by the neural network when failing to obtain the indication that the object is captured by the sensed information unit.

The indication may be location specific—for example may indicate the expected location (or indicate a set of possible locations) of the objects—and in this case the detection of the object by the neural network may be approved if the location of the detection as indicated by the neural network output is the same as substantially the same as the location of the detection as indicated by the neural network output.

The detection limitation may be an object size limitation—for example the object is outside a certain size range in which the neural network output is deemed accurate (at the absence of the indication).

For example—the neural network may be trained to detect objects within a certain size range with the at least the desirable certainty, and is configured to detect objects outsize the certain size range at a certainty the is lower than the desirable certainty.

Step 125 may include obtaining the indication as a result of tracking after the object, while a distance between the object and a sensor of the sensed information unit changes from a distance in which the object is within the certain size range to a distance in which the object is outside the certain size range.

Step 125 may include obtaining the indication as a result of tracking after the object, while the object moves from a high resolution region of the sensed information unit to a low resolution region of the sensed information unit.

Step 140 may be followed by step 160 of performing a driving related operation based on the detecting of the object by the neural network.

Step 160 may include autonomously driving the vehicle.

Step 160 may include performing an advanced driver assistance system (ADAS) operation.

Method 100 is executed in real time, and per image. Thus—method 100 may be calculated many times (tens, hundreds, and the like)—especially when used for impacting the driving of the vehicle.

Method 100 solves detection limitations of neural networks without dramatically increasing (and even without increasing at all) the size of the neural network—thus saving computational and/or memory resources—while increasing the sensitivity of detection—thereby provides significant computer science improvements.

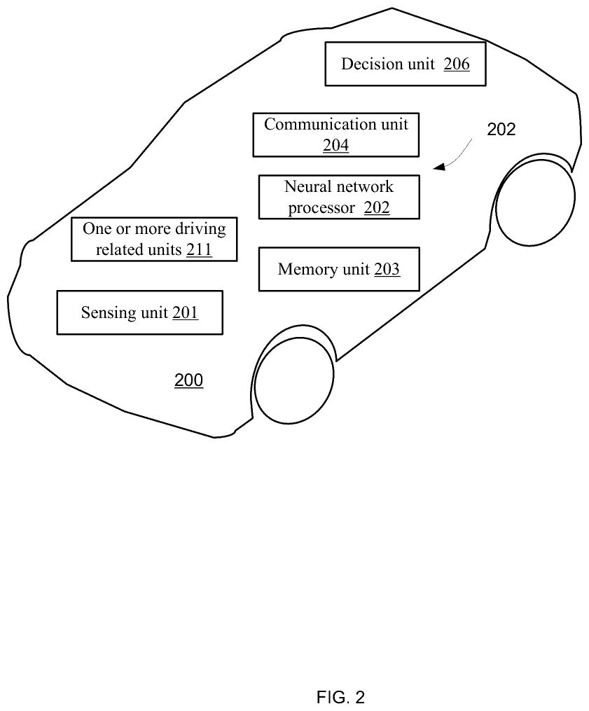

FIG. 2 illustrates a vehicle 200 and a vehicle system 202 for overcoming a detection limitation of a neural network using additional knowledge.

Vehicle system 200 is located within the vehicle (or has at least some units such as a neural network processor located within the vehicle.

Vehicle system 200 may include neural network processor 202, communication unit 204, and decision unit 206.

According to an embodiment, the neural network processor 202 is a processor adapted to perform neural network processing—according to an embodiment it includes neural network processing accelerators, and the like.

According to an embodiment the memory unit 203 includes at least one of a memory chip, flip-flops, buffers, a memory controller, and the like. According to an embodiment the communication unit is configured to obtain sensed information unit that captures an object.

The detection limitation of the neural network prevents the neural network from generating a neural network output that is indicative of the object with at least a desirable certainty.

According to an embodiment, the communication unit 204 is configured to receive the indication that the object is captured by the sensed information unit.

According to an embodiment, the communication unit 204 is also configured to feed the sensed information unit to the neural network processor.

According to an embodiment, the neural network processor 202 is configured to implement to the neural network output and to process the sensed information unit to generate the neural network output.

According to an embodiment, the decision unit 206 is configured to (i) approve a detecting of the object by the neural network when obtaining an indication that the object is captured by the sensed information unit; and (ii) ignore the detecting of the object by the neural network when failing to obtain the indication.

According to an embodiment, the indication includes one or more predicted locations of the object.

According to an embodiment, the vehicle includes a sensing unit 201 such as a vehicle camera or any number of any sensing units), memory unit 203 for storing information and/or instructions (any type of non-transitory memory units may be used), and one or more driving related units 211 such as (i) one or more autonomous driving units that is configured to control or otherwise execute autonomous driving and/or (ii) one or more driver assistance units such as ADAS units. The vehicle is configured to execute any of the mentioned above methods.

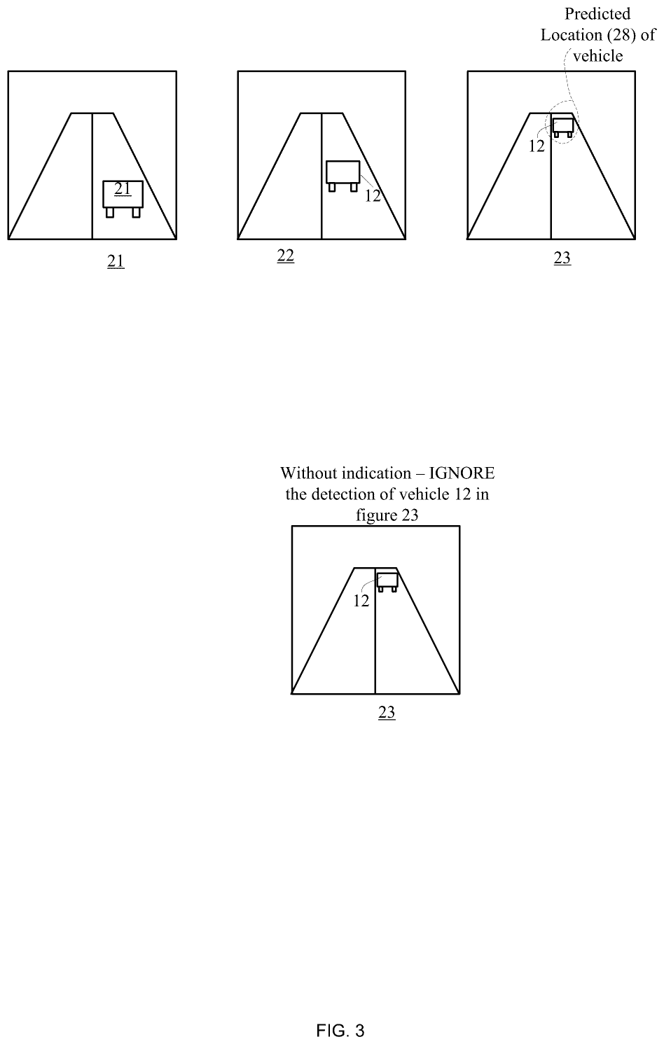

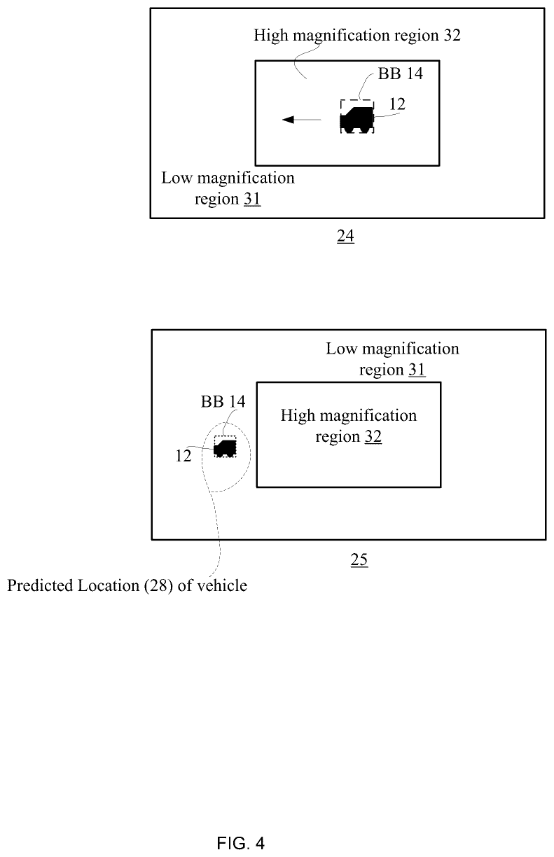

FIGS. 3 and 4 illustrate examples of detecting of vehicles 12 that are too small (or having a too small bounding box) to be regarded as being detected by the object detection neural network—at an absence of an additional information.

FIGS. 3 and 4 also illustrate the detection which is based on an indication (for example an estimated location of the vehicle)—in which the decision unit will not ignore the detection made by the neural network.

In FIG. 3 there are illustrated three images 21, 22 and 23 in which another vehicle 21 increases the distance from the vehicle camera. In image 23 the vehicle 12 is too small to be reliably detected by the neural network—but due to the additional information—prediction (for example based on location of the vehicle in images 21 and 22 and timing difference between the acquisition of the images)—may be used to approve the (otherwise disapproved) detection made by the neural network. The disapproval is illustrated below—as an indication about the vehicle is not obtained.

FIG. 4 illustrates two images 24 and 25—in which vehicle 12 (bounded by bounding box BB)14) moves from a high magnification region 31 (in which BB14 is large enough to allow neural network detection without further assistance)—to a low magnification region 31 in which the vehicle and BB are smaller than the minimal threshold required for detection without assistance. The predicted location (28) of the vehicle is used to approve the detection of the vehicle (by the neural network) in both cases.

Any combination of any module or unit listed in any of the figures, any part of the specification and/or any claims may be provided. Especially any combination of any claimed feature may be provided.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on non-transitory computer readable media permanently, removably or remotely coupled to an information processing system. The non-transitory computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method that is computer implemented and is for overcoming an object detection limitation of a neural network, the method comprises:
obtaining a sensed information unit that captures an object;
obtaining an indication for a detection limitation of the neural network with respect to the object, wherein the detection limitation of the neural network prevents the neural network from generating a neural network output that is indicative of the object with at least a desirable certainty;
feeding the sensed information unit to the neural network to provide a neural network output; and
controlling a detection of the object by the neural network based on an indication that the object is captured in the sensed information unit.

2. The method according to claim 1, wherein the controlling comprises approving the detection of the object by the neural network when obtaining the indication that the object is captured by the sensed information unit; and ignoring the detection of the object by the neural network when failing to obtain the indication that the object is captured by the sensed information input.

3. The method according to claim 2, wherein the approving of the detecting of the object by the neural network is conditioned by obtaining the indication that the object is captured by the sensed information unit at a location indicated by the neural network.

4. The method according to claim 1, wherein the detection limitation is an object size limitation.

5. The method according to claim 1, wherein the neural network is trained to detect objects within a specified size range within the desirable certainty, and is configurable for object detection beyond the specified size range at a certainty the is lower than the desirable certainty.

6. The method according to claim 5, wherein the indication that the object is captured by the sensed information unit is provided when tracking after the object, while a distance between the object and a sensor of the sensed information unit changes from a distance in which the object is within the specified size range to a distance in which the object is beyond the specified size range.

7. The method according to claim 5, wherein the indication that the object is captured by the sensed information unit is provided when tracking after the object, while the object moves from a high resolution region of the sensed information unit to a low resolution region of the sensed information unit.

8. The method according to claim 1, further comprising performing a driving related operation based on the detecting of the object by the neural network.

9. The method according to claim 8, wherein the performing of the driving related operation comprises autonomously driving the vehicle.

10. The method according to claim 8, wherein the performing of the driving related operation comprises performing an advanced driver assistance system (ADAS) operation.

11. A non-transitory computer readable medium storing instructions that, when executed by at least one processor, cause the at least one processor to perform operations for overcoming a detection limitation of a neural network, comprising:
obtaining a sensed information unit that captures an object;
obtaining an indication for a detection limitation of the neural network with respect to the object, wherein the detection limitation of the neural network prevents the neural network from generating a neural network output that is indicative of the object with at least a desirable certainty;
feeding the sensed information unit to the neural network to provide a neural network output; and
controlling a detection of the object by the neural network based on an indication that the object is captured in the sensed information unit.

12. The non-transitory computer readable medium according to claim 11, wherein the controlling comprises approving the detection of the object by the neural network when obtaining the indication that the object is captured by the sensed information unit; and ignoring the detection of the object by the neural network when failing to obtain the indication that the object is captured by the sensed information input.

13. The non-transitory computer readable medium according to claim 12, wherein the approving of the detecting of the object by the neural network is conditioned by obtaining the indication that the object is captured by the sensed information unit at a location indicated by the neural network.

14. The non-transitory computer readable medium according to claim 11, wherein the detection limitation is an object size limitation.

15. The non-transitory computer readable medium according to claim 11, wherein the neural network is trained to detect objects within a specified size range within the desirable certainty, and is configurable for object detection beyond the specified size range at a certainty the is lower than the desirable certainty.

16. The non-transitory computer readable medium according to claim 15, wherein the indication that the object is captured by the sensed information unit is provided when tracking after the object, while a distance between the object and a sensor of the sensed information unit changes from a distance in which the object is within the specified size range to a distance in which the object is beyond the specified size range.

17. The non-transitory computer readable medium according to claim 15, wherein the indication that the object is captured by the sensed information unit is provided when tracking after the object, while the object moves from a high resolution region of the sensed information unit to a low resolution region of the sensed information unit.

18. The non-transitory computer readable medium according to claim 11, that stores instructions for performing a driving related operation based on the detecting of the object by the neural network.

19. The non-transitory computer readable medium according to claim 18, wherein the performing of the driving related operation comprises autonomously driving the vehicle.

20. The non-transitory computer readable medium according to claim 18, wherein the performing of the driving related operation comprises performing an advanced driver assistance system (ADAS) operation.
